(19) United States
(12) Patent Application Publication
(10) Pub. No.: US 2025/0217021 A1
(43) Pub. Date: Jul. 3, 2025

(54) RAPID VECTOR COORINDATE ALIGNMENT TOOL

(71) Applicant: 52 Stairs Studio Inc., Ontario (CA)

(72) Inventor: Jonathan Wagner, Ontario (CA)

(21) Appl. No.: 18/981,848

(22) Filed: Dec. 16, 2024

Related U.S. Application Data
(60) Provisional application No. 63/615,156, filed on Dec. 27, 2023.

(51) Int. Cl. G06F 3/04845; G06F 3/04812; G06F 3/0482; G06T 3/153; G06T 11/60

(52) U.S. Cl. CPC G06F 3/04845; G06F 3/04812; G06F 3/0482; G06T 3/153; G06T 11/60; G06T 2200/24

(57) ABSTRACT

A computer-implemented method for aligning vector coordinates may include receiving vector data representing boundaries of vector-represented features. A visual representation of the vector data may be displayed on a graphical user interface. A cursor and threshold indicator may be provided on the interface. At least two potential edges for alignment may be identified within the threshold indicator area. A user selection of an alignment method and input defining an extent of alignment may be received. New alignment points may be calculated based on the selected method and defined extent. The vector data may be modified to incorporate the calculated new alignment points. The method may provide real-time visual feedback during the alignment process. Configuration options may allow customization of the threshold indicator size, alignment method, and other parameters.

### RELATED APPLICATION

Under provisions of 35 U.S.C. § 119(e), the Applicant claims benefit of U.S. Provisional Application No. 63/615,156 filed on Dec. 27, 2023, and having inventors in common, which is incorporated herein by reference in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to digital data manipulation and visualization systems. More specifically, it pertains to vector-based graphical representations used in geographic information systems (GIS) and/or graphic design software, particularly addressing the alignment of vector coordinates at boundaries within these systems.

### BACKGROUND

In some situations, aligning vector coordinates in software, and particularly in Geographic Information Systems (GIS) and graphic design software, can be challenging and time-consuming for users. For example, when working with complex map data or intricate graphic designs, precise alignment of vector elements may be crucial for maintaining spatial relationships and/or visual aesthetics. Thus, the conventional strategy is to manually adjust individual vertex points or use basic snapping tools. This often causes problems because the manual process is labor-intensive and requires specialized knowledge of software tools. For example, aligning multiple vector objects across a large dataset can take considerable time and effort, potentially leading to inconsistencies and errors.

Existing alignment tools in GIS and graphic design software may not be suitable for efficient and accurate vector coordinate alignment due to their complexity and lack of intuitive user interfaces. These tools typically require users to have in-depth knowledge of the software and its functionalities, which can be a barrier for less experienced users. Additionally, current alignment methods often lack real-time visual feedback, making it difficult for users to achieve precise alignments without multiple attempts and adjustments.

The process of maintaining geometric integrity while aligning vector elements can also present challenges with conventional methods. When adjusting vector coordinates, users may inadvertently distort the shape or structure of the objects, compromising the overall quality of the data or design. Furthermore, existing tools may not adequately address the need for versatility across different technical fields, as the requirements for alignment in GIS applications can differ significantly from those in graphic design contexts.

Another limitation of current approaches is the difficulty in resolving issues such as gaps or overlaps between adjoining vector features. These inconsistencies can lead to inaccuracies in spatial analyses or compromised visual designs, requiring additional time and effort to correct. The lack of automated processes for detecting and resolving these alignment issues further contributes to the inefficiency of existing methods.

Thus, there is a need for a more intuitive and efficient approach to vector coordinate alignment that can be applied across various technical fields. Such a system may need to provide a user-friendly interface with real-time visual feedback, while also maintaining the geometric integrity of vector elements. Implementing technical solutions to streamline the alignment process while catering to users with varying levels of expertise may present challenges in balancing simplicity with functionality.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In some embodiments, a computer-implemented method for aligning vector coordinates may receive, by a processor, vector data representing boundaries of features comprised of vector points (e.g., geographic features, graphic design elements, etc.). The method may display, on a graphical user interface, a visual representation of the vector data. A cursor may be provided on the graphical user interface. A threshold indicator may be displayed around the cursor, wherein the threshold indicator may define an area for identifying potential edges for alignment.

The method may detect a user input to initiate an alignment process. At least two potential edges for alignment may be identified within the threshold indicator area. A user selection of an alignment method may be received from a plurality of alignment methods. A user input defining an extent of alignment along the identified potential edges may be received. New alignment points may be calculated based on the selected alignment method and defined extent. The vector data may be modified to incorporate the calculated new alignment points.

In other embodiments, a system for aligning vector coordinates may comprise a display device, a processor, and a memory storing instructions. The instructions, when executed by the processor, may cause the system to display a graphical user interface on the display device. Vector data representing boundaries of vector features may be rendered on the graphical user interface. A cursor and a threshold indicator around the cursor may be provided on the graphical user interface. User inputs for selecting potential edges for alignment within the threshold indicator may be detected.

In yet other embodiments, a non-transitory computer-readable medium may store instructions that, when executed by a processor, cause the processor to perform a method for aligning vector coordinates. The method may display a graphical user interface with vector data representing boundaries of features comprised of vector points. A cursor and a threshold indicator around the cursor may be provided on the graphical user interface. User inputs for selecting potential edges for alignment within the threshold indicator may be detected. A selection of an alignment method may be received from a plurality of alignment methods.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a vector alignment platform;

FIG. 3 illustrates an example of misaligned vector regions;

FIG. 4 illustrates an example of visual feedback showing potential alignment of candidate vector edges;

FIG. 5 shows an example of a “meet in the middle” alignment;

FIG. 6 illustrates an example of a “meet at first edge” alignment; and

FIG. 7 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of a border alignment platform, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The system may include a graphical user interface (GUI) for displaying vector data representing boundaries of vector-represented features (e.g., geographic features, graphic design elements, and/or the like). The GUI may provide a cursor and a threshold indicator around the cursor. The threshold indicator may define an area for identifying potential edges for alignment.

The system may detect user inputs for selecting potential edges for alignment within the threshold indicator area. This may involve the user moving the cursor near edges they wish to align and the system identifying edges within the threshold area around the cursor.

The system may receive a selection of an alignment method from the user. The alignment methods may include options such as (but not limited to) “meet in the middle” or “meet at first edge”.

When the user initiates an alignment process, such as by clicking and dragging, the system may calculate new alignment points based on the selected alignment method and user inputs. This may involve determining how to adjust the vector data to align the selected edges according to the chosen method.

The system may then modify the vector data to incorporate the calculated new alignment points, effectively aligning the selected edges.

Real-time visual feedback may be provided during the alignment process. This feedback may include, as a non-limiting example, a preview of the newly aligned edge and/or directional indicators pointing from existing edges towards the newly aligned edge.

Configuration options may be provided to customize aspects of the alignment process. These options may include, but are not limited to, adjusting the size of the threshold indicator, selecting the alignment method, and toggling a “square ends” option to maintain angular geometry at the start and end of aligned edges.

The alignment process may occur in stages, including:
1. A discovery stage for selecting initial points for edge alignment
2. A selection stage for defining the extent of alignment
3. An alignment stage for executing the alignment and modifying the vector data

This staged approach may allow the user to precisely control the alignment operation through an intuitive interface.

Embodiments of the present disclosure may comprise methods, systems, and a computer readable medium comprising, but not limited to, at least one of the following:
A. An Interface Module
B. An Edge Identification Module
C. An Alignment Determination Module
D. A Vector Modification Module

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 700 may be employed in the performance of some or all of the stages disclosed with regard to the methods. Similarly, an apparatus may be employed in the performance of some or all of the stages of the methods. As such, the apparatus may comprise at least those architectural components as found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving, by a processor, vector data representing boundaries of vector-represented features;
displaying, on a graphical user interface, a visual representation of the vector data;
providing a cursor on the graphical user interface;
displaying a threshold indicator around the cursor, wherein the threshold indicator defines an area for identifying potential edges for alignment;
detecting a user input to initiate an alignment process;
identifying, within the threshold indicator area, at least two potential edges for alignment;
receiving a user selection of an alignment method from a plurality of alignment methods;
receiving a user input defining an extent of alignment along the identified potential edges;
calculating new alignment points based on the selected alignment method and defined extent; and
modifying the vector data to incorporate the calculated new alignment points.

Although the aforementioned method has been described to be performed by the platform 100, it should be understood that computing device 700 may be used to perform the various stages of the method. Furthermore, in some embodiments, different operations may be performed by different networked elements in operative communication with computing device 700. For example, a plurality of computing devices may be employed in the performance of some or all of the stages in the aforementioned method. Moreover, a plurality of computing devices may be configured much like a single computing device 700. Similarly, an apparatus may be employed in the performance of some or all stages in the method. The apparatus may also be configured much like computing device 700.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

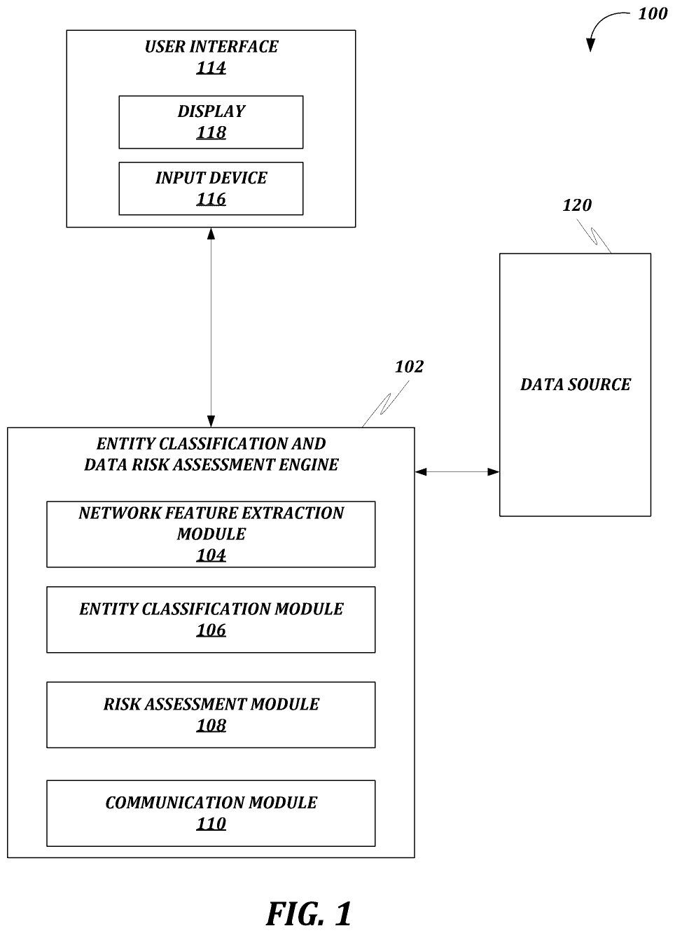

FIG. 1 illustrates one possible operating environment through which a platform consistent with embodiments of the present disclosure may be provided. By way of non-limiting example, a vector alignment platform 100 may be hosted on, for example, a cloud computing service. In some embodiments, the platform 100 may be hosted on a computing device 700. A user may access platform 100 through a software application and/or hardware device. The software application may be embodied as, for example, but not be limited to, a website, a web application, a desktop application, and a mobile application compatible with the computing device 700.

In embodiments, the platform 100 may include vector alignment engine 102. The vector alignment engine 102 may comprise, be embodied on, or otherwise be compatible with a computing device 700. The vector alignment engine 102 may be operatively connected with one or more of a user interface 114 and/or a data source 120, and various components thereof. In one or more embodiments, the platform 100 may include more or fewer components than the components illustrated in FIG. 1. The components illustrated in FIG. 1 may be local to or remote from each other.

In one or more embodiments, the user interface 114 refers to hardware and/or software configured to facilitate communications between a user and the vector alignment engine 102. The user interface 114 may be used by a user who accesses an interface (e.g., a dashboard interface) for work and/or personal activities. The user interface 114 may receive user input from one or more input devices 116. The input device may include, but need not be limited to, a keyboard and/or one or more indicating devices (e.g., a mouse, trackball, trackpad, tablet, and/or any other device for use in moving a cursor).

The user interface 114 may be associated with one or more devices for presenting visual media, such as a display device 118, including (but not limited to) a monitor, a television, a projector, and/or the like. User interface 114 renders user interface elements and receives input via user interface elements. Examples of interfaces include a graphical user interface (GUI), a command line interface (CLI), a haptic interface, and a voice command interface. Examples of user interface elements include cursors, checkboxes, radio buttons, menus, dropdown lists, list boxes, buttons, toggles, text fields, date and time selectors, command lines, sliders, pages, and forms.

Accordingly, embodiments of the present disclosure provide a software and hardware platform comprised of a distributed set of computing elements, including, but not limited to:

### A. An Interface Module

In embodiments, the vector alignment engine 102 may include an interface module 104. The interface module 104 may refer to hardware and/or software configured to perform operations described herein (including such operations as may be incorporated by reference) for displaying a graphical user interface (GUI) that allows users to interact with and control the vector alignment functionality. The interface module 104 may be configured to render vector data to produce visible shapes. on the display device 118. In various embodiments the vector data may represent, as non-limiting examples, boundaries of geographic features or graphic design elements.

The module 104 may provide a cursor on the GUI for selecting potential edges to align. In some embodiments, the cursor may include a threshold indicator. The threshold indicator may be an area (e.g., a circular, oval, rectangular, or other-shaped region) around the cursor that defines the proximity for identifying alignable edges.

The threshold indicator may be displayed as a region or area surrounding the cursor on the graphical user interface. The shape provides a clear visual boundary for identifying potential edges for alignment. The size and/or shape of the threshold indicator may be configurable by the user. For example, the user may be able to adjust the radius of a circular indicator. The shape remains circular but the diameter can be increased or decreased based on user preference or the level of precision needed for a particular alignment task. Additionally or alternatively, the user may select a shape other than circular (e.g., rectangular, oval, etc.).

The threshold indicator moves in tandem with the cursor as the user moves the pointing device across the interface. The center of the circular indicator remains fixed to the cursor position at all times. This allows the user to dynamically scan different areas of the vector data to identify potential edges for alignment. As the threshold indicator moves with the cursor, the system may continuously analyze the vector data within the circular area to detect potential edges for alignment. Visual feedback, such as highlighting or arrows, may be provided in real-time to indicate which edges fall within the threshold area and are available for alignment.

The threshold indicator may serve as a visual guide for the user and a functional boundary for the edge detection algorithm. By adjusting the size of the threshold indicator, users can control the sensitivity of edge detection-a larger circle allows for detecting edges that are further apart, while a smaller circle provides more precise control over which edges are selected for alignment. This implementation of the threshold indicator provides an intuitive and flexible way for users to identify and select edges for alignment, enhancing the overall usability of the vector coordinate alignment tool.

The interface module may display real-time visual feedback during the alignment process, such as (but not limited to) previews of new aligned edges and/or directional indicators pointing from existing edges to potential new alignments. This visual feedback may include several elements to clearly indicate potential alignments and preview the results.

One visual feedback element may be directional indicators pointing from the existing edges towards the new aligned edge. These indicators may take the form of arrows or lines emanating from the original edge vertices. The directional indicators may dynamically update as the user moves the cursor to show the current alignment direction.

The platform 100 may display a preview line or curve showing the potential new aligned edge. This preview may be rendered as, for example and not by way of limitation, a dashed or semi-transparent line to distinguish it from the existing edges. The preview may update in real-time as the user drags the cursor to define the extent of alignment.

For generating and displaying the alignment previews, the platform 100 may perform rapid calculations of the potential new edge coordinates based on the current cursor position and selected alignment method. These calculations may leverage the edge identification and alignment determination modules to compute interim results without modifying the underlying vector data.

The preview generation process may involve interpolating points along the potential new edge path at a suitable density for smooth rendering. The computing device 700 may apply any relevant options like square ends when generating the preview.

To enhance visibility, the computing device 700 may render the preview and directional indicators using a contrasting color or effect that stands out against the existing vector graphics. The visual style may be configurable to suit different use cases and user preferences.

The directional indicators may take different forms depending on the selected alignment method. For “meet in middle” alignment, bidirectional arrows may point from both original edges towards the average line. For “meet at first edge” alignment, unidirectional arrows may point from the second edge to the first.

The module 104 may provide visual cues to indicate the current extent of alignment as the user drags. This may include highlighting or emphasizing the relevant portions of the original edges that will be affected by the alignment operation.

The module 104 may present configuration options to the user. The configuration options may include options that enable he user to adjust various settings of the platform 100, such as threshold indicator size, alignment method selection, square ends toggle, and/or the like.

The interface module 104 may detect and process user inputs (e.g., cursor movements, clicks, and drags). These inputs may be used, for example, to initiate and/or control the alignment process. The module 104 may update the GUI in real-time to reflect changes as the user performs alignment operations.

The interface module 104 may work in conjunction with other modules to enable an intuitive click-and-drag interaction for aligning vector edges. It may handle the visual presentation and user input aspects of the alignment tool, while coordinating with backend modules that perform the actual vector data processing and modifications.

### B. An Edge Identification Module

In embodiments, the vector alignment engine 102 may include an edge identification module 106. The edge identification module 106 may refer to hardware and/or software configured to perform operations described herein (including such operations as may be incorporated by reference) to identify potential edges for alignment within the threshold area around the cursor. In some embodiments, the edge identification module 106 may analyze vector data representing boundaries (e.g., of geographic features or graphic design elements) to detect edges that fall within the threshold area.

The edge identification module 106 may utilize various edge detection algorithms to identify edges in the vector data. In one implementation, the module 106 may scan the vector coordinates within the threshold area and detect significant changes in coordinate values that indicate the presence of an edge. The module 106 may apply smoothing or filtering techniques to reduce noise and improve edge detection accuracy.

In some embodiments, the edge identification module 106 may classify detected edges based on characteristics such as length, orientation, or proximity to other edges. This classification may be used to prioritize certain edges for alignment or to provide additional context to the user.

The edge identification module 106 may work in conjunction with the interface module 104 to visually highlight potential edges for alignment on the graphical user interface. In one implementation, the module 106 may generate graphical indicators such as arrows or highlighted outlines to draw the user's attention to alignable edges within the threshold area.

In various embodiments, the edge identification module 106 may dynamically update the set of potential edges for alignment as the user moves the cursor. The module 106 may continuously analyze the vector data within the moving threshold area and refresh the identified edges in real-time.

The edge identification module 106 may also consider settings associated with the platform 100 when identifying potential edges. For example, the module 106 may adjust its edge detection sensitivity based on the user-defined threshold size. A larger threshold area may result in more potential edges being identified, while a smaller area may limit the number of edges detected.

In some implementations, the edge identification module 106 may employ machine learning techniques to improve edge detection over time. The module 106 may analyze user alignment patterns and feedback to refine its edge identification algorithms and better predict which edges are most likely to be aligned.

### C. An Alignment Determination Module

In embodiments, the vector alignment engine 102 may include an alignment determination module 108. The alignment determination module 108 may refer to hardware and/or software configured to perform operations described herein (including such operations as may be incorporated by reference) for calculating and/or otherwise determining alignments between vector edges (e.g., edges of two adjacent shapes, or two adjacent edges of a single shape). In some embodiments, the alignment determination module 108 may receive user input specifying an alignment method and an extent of alignment along selected edges.

The alignment determination module 108 may be configured to support multiple alignment methods. In one implementation, the module 108 may provide a “meet in the middle” method that generates an average line between two selected edges. For this method, the module 108 may calculate a plurality of intersection points between the selected edges and determine midpoints to create the aligned edge. Additionally or alternatively, the alignment determination module 108 may offer a “meet at first edge” method that aligns a second edge to a first selected edge. For this approach, the module 108 may analyze the geometry of the first edge and calculate how to adjust the second edge to match. The platform 100 may apply the selected alignment algorithm to complex edge geometries in various ways. For curved or irregular edges, the platform 100 may use interpolation techniques to generate corresponding points along each edge for alignment calculations. This may involve creating a series of evenly spaced points along each edge within the defined extent of alignment. In some implementations, the platform 100 may employ curve fitting algorithms to approximate complex edge geometries with simpler mathematical representations, such as Bezier curves or splines. The alignment calculations may then be performed on these simplified representations.

For edges with sharp corners or discontinuities, the platform 100 may treat each segment separately for alignment purposes. The alignment algorithm may be applied to individual segments, with special handling at the junction points to maintain overall geometric consistency.

In cases where the edges to be aligned have significantly different levels of detail or complexity, the platform 100 may use adaptive sampling techniques. This approach may involve generating more alignment points in areas of high curvature or detail, and fewer points in straighter or simpler sections.

The platform 100 may handle special cases or edge conditions in the alignment process through various mechanisms. For intersecting edges, the platform 100 may identify one or more intersection points and use the identified point(s) as a fixed reference for alignment calculations.

When aligning edges with different lengths, the platform 100 may optionally employ stretching or compressing algorithms to distribute the alignment points evenly along both edges. This may involve interpolating additional points on the shorter edge or removing points from the longer edge.

In cases where one edge extends beyond the other, the platform 100 may extrapolate the alignment beyond the extent of the shorter edge. This extrapolation may be based on the geometric properties of the existing edge, such as its curvature or direction.

For edges that form closed loops or polygons, the platform 100 may implement special logic to ensure that the alignment preserves the closed nature of the shape. This may involve adjusting the first and last points of the alignment to maintain continuity.

The platform 100 may also handle cases where multiple edges intersect at a single point, such as in complex junctions or nodes. In these scenarios, the alignment algorithm may prioritize maintaining the relative angles between the intersecting edges while adjusting their positions.

For edges that are nearly parallel but not quite aligned, the platform 100 may implement a snapping threshold. If the distance between the edges falls below this threshold, the alignment may automatically snap to a perfectly parallel configuration.

In some implementations, the platform 100 may provide options for user-defined constraints or rules for handling special cases. These may include specifying minimum distances between aligned edges, preserving certain geometric relationships, or defining custom alignment behaviors for specific edge types or configurations.

The platform 100 may employ error handling and validation mechanisms to detect and address potential issues in the alignment process. This may include checking for self-intersections, topology violations, or other geometric inconsistencies that could result from the alignment operation.

In cases where the alignment operation would result in invalid geometry, the platform 100 may provide warnings or suggestions to the user. These may include recommendations for alternative alignment methods or adjustments to the alignment parameters.

The platform 100 may implement undo and redo functionality specifically tailored to the alignment operations. This may allow users to easily revert changes or experiment with different alignment configurations without risking data loss.

In some embodiments, the platform 100 may provide options for batch processing or applying alignment operations to multiple sets of edges simultaneously. This may be particularly useful for aligning large datasets or performing consistent adjustments across an entire map or design.

The platform 100 may implement a preview mode for complex alignment operations. This preview may show the potential results of the alignment before it is applied, allowing users to assess the impact and make adjustments as needed.

For edges that represent boundaries between different features or properties, the platform 100 may provide options to maintain or adjust attribute data associated with the aligned edges. This may include mechanisms for merging, averaging, or selectively preserving attribute values during the alignment process.

In some implementations, the platform 100 may offer advanced options for controlling the behavior of the alignment algorithms in special cases. These options may include parameters for adjusting the weight given to different geometric properties, specifying custom alignment rules, or defining tolerance levels for various aspects of the alignment process.

The platform 100 may also provide one or more mechanisms for handling alignment operations that span multiple coordinate systems or projections. This may involve on-the-fly coordinate transformations or the ability to align edges across different layers or data sources while maintaining their relative spatial relationships.

The alignment determination module 108 may be configured to handle complex alignment scenarios involving multiple edges or intersections. In some embodiments, the module 108 may employ computational geometry algorithms to resolve alignments between intersecting and/or overlapping vector features.

In various implementations, the alignment determination module 108 may calculate new alignment points based on the selected method and/or the user-defined extent of alignment. The module 108 may determine how to adjust the original vector data to create the aligned edges while maintaining topological relationships with non-aligned features.

The alignment determination module 108 may work in conjunction with other modules to provide an interactive alignment experience. In one embodiment, the module 108 may receive edge information from the edge identification module 106 and use it to determine potential alignment options. The module 108 may then provide calculated alignment data to the vector modification module 110 for implementation.

In some implementations, the alignment determination module 108 may support a “square ends” functionality. When enabled, the module 108 may calculate additional points at the start and end of aligned edges to preserve angular geometry at edge endpoints. This may involve analyzing the angles of adjacent line segments and determining optimal square end positions.

The alignment determination module 108 may be designed to perform calculations efficiently to enable real-time visual feedback during the alignment process. In one embodiment, the module 108 may employ parallel processing techniques to quickly compute multiple potential alignments as the user interacts with the interface.

### D. A Vector Modification Module

In embodiments, the vector alignment engine 102 may include a vector modification module 110. The vector modification module 110 may refer to hardware and/or software configured to perform operations described herein (including such operations as may be incorporated by reference) for modifying vector data to incorporate calculated new alignment points. In some embodiments, the vector modification module 110 may receive alignment data from the alignment determination module 108 and use it to update the underlying vector data structures.

The vector modification module 110 may be configured to splice new alignment points into existing vector edges at specified index positions. In one implementation, the module 110 may insert the new points into arrays or linked lists representing the vector geometry. The module 110 may be designed to handle different vector data formats and structures commonly used in GIS and graphic design software.

In various embodiments, the vector modification module 110 may preserve topological relationships between vector features during the alignment process. The module 110 may analyze adjacent features and update their geometries as needed to maintain proper connectivity. For example, when aligning a boundary between two polygons, the module 110 may modify both polygons to reflect the new aligned edge.

The vector modification module 110 may be configured to support different alignment methods. For a “meet in the middle” alignment, the module 110 may insert averaged points calculated by the alignment determination module into both edges being aligned. For a “meet at first edge” alignment, the module 110 may copy points from the first edge and insert them into the second edge at corresponding index positions.

In some implementations, the vector modification module 110 may add additional points to create square ends when that option is selected. The module 110 may analyze the angles of adjacent line segments and insert new points to maintain perpendicular geometry at the start and end of aligned edges.

The vector modification module 110 may be designed to handle complex vector geometries efficiently. In one embodiment, the module 110 may employ spatial indexing techniques to quickly locate and update relevant portions of large vector datasets. The module 110 may also utilize parallel processing to modify multiple vector features simultaneously when possible.

In an embodiment, the vector alignment engine 102 is configured to receive data from one or more data sources 120. A data source 120 may refer to hardware and/or software operating independent of the engine 102 (e.g., an external data source) and/or a data source that is part of the vector alignment platform 100. A data source 120 may include, for example, a storage repository for GIS vector data, a data store maintaining vector data for graphic design elements, and/or the like.

In some embodiments (e.g., where the data source 120 is an external data source), the engine 102 is configured to retrieve data from an external data source 120 by ‘pulling’ the data via an application programming interface (API) of the external data source 120, using user credentials that a user has provided for that particular external data source 120. Alternatively or additionally, the external data source 120 may be configured to ‘push’ data to the vector alignment engine 102 via an API of the query suggestion service, using an access key, password, and/or other kind of credential that a user has supplied to the external data source 120. In other embodiments, (e.g., where the data source 120 is an internal data source) the engine 102 may retrieve data via known data access techniques utilizing one or more data buses. The entity classification and data risk assessment engine 102 may be configured to receive data from data source 120 in many different ways.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 700 may be employed in the performance of some or all of the stages disclosed with regard to the methods. Similarly, an apparatus may be employed in the performance of some or all of the stages of the methods. As such, the apparatus may comprise at least those architectural components found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

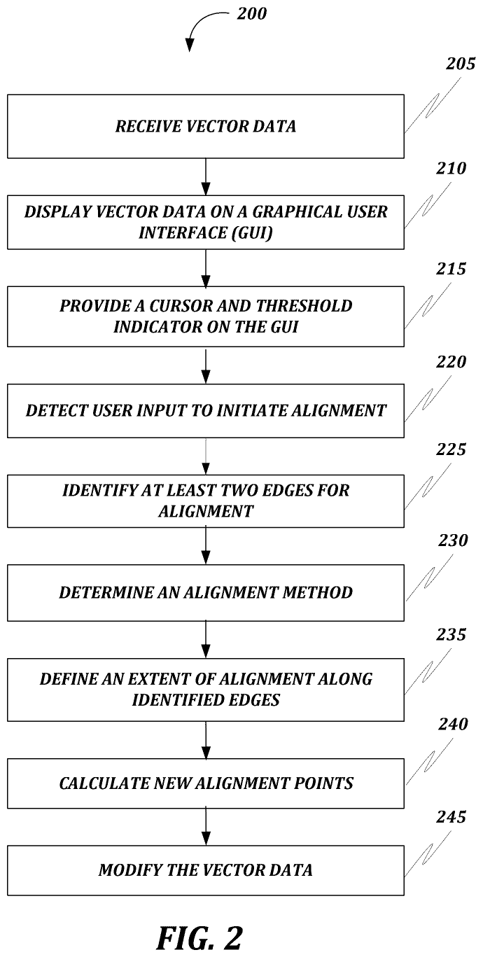

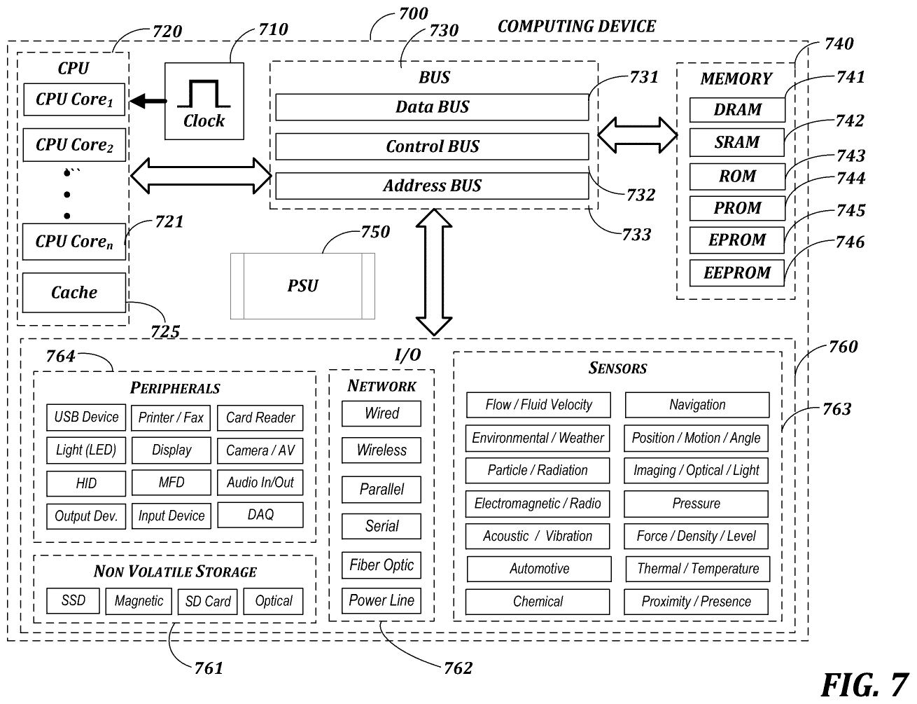

FIG. 2 is a flow chart setting forth the general stages involved in a method 200 consistent with an embodiment of the disclosure for providing a vector alignment platform 100. Method 200 may be implemented using a computing device 700 or any other component associated with platform 100 as described in more detail below with respect to FIG. 7. For illustrative purposes alone, computing device 700 is described as one potential actor in the following stages.

Method 200 may begin at stage 205 where computing device 700 may receive vector data. The vector data may comprise coordinate information defining the shapes and locations of various elements, such as (but not limited to) graphic design elements, geographic elements, political boundaries, coastlines, roads, or other spatial features.

The processor may receive the vector data from one or more data sources. In some implementations, the one or more data sources may include a local database stored on the same computing device as the processor. Additionally or alternatively, the one or more data sources may include a remote server or cloud-based storage system accessible over a network connection.

The vector data may be received in various standardized data formats. In some embodiments, the vector data may be in a shapefile format, which includes geometric and attribute information for spatial features. In other embodiments, the vector data may be in formats such as GeoJSON, KML, GML, and/or any other computer-readable vector format.

Upon receiving the vector data, the processor may parse and interpret the coordinate information to extract boundary definitions for the features. This may involve reading vertex coordinates that define polylines or polygons representing the feature boundaries.

In some implementations, the processor may perform initial validation and error checking on the received vector data. This may include verifying that the coordinates are within expected ranges, checking for topological errors, or identifying gaps or overlaps between adjacent features.

The processor may store the received vector data in memory for subsequent processing and manipulation during the alignment operations. In some embodiments, the vector data may be loaded into a spatial data structure such as a quadtree or R-tree to enable efficient spatial querying and analysis.

In various implementations, metadata associated with the vector data may also be received and processed. This metadata may include information such as the coordinate reference system, feature attributes, or data provenance details.

At stage 210, the computing device may display a visual representation of the received vector data. The visual representation may comprise a map or diagram showing the features represented by the vector data.

In some embodiments, the visual representation may be rendered as a two-dimensional image on a graphical user interface. The two-dimensional image may depict the boundaries, shapes, and spatial relationships of the features encoded in the vector data.

In other embodiments, the visual representation may be rendered as a three-dimensional model that can be rotated, panned, and/or zoomed by the user. The three-dimensional model may provide depth and elevation information for the features in addition to their two-dimensional boundaries.

The visual representation may use different colors, patterns, or symbols to distinguish between different types of features or attributes encoded in the vector data. For example, in the case of a map, water features may be displayed in blue, while land features may be displayed in green.

In some implementations, the visual representation may include labels or annotations to identify specific features or provide additional information about them. These labels may be dynamically generated based on attributes in the vector data.

The graphical user interface may provide controls to allow the user to adjust the display of the visual representation. For example, the user may be able to toggle different layers of features on and off, adjust transparency levels, and/or change the styling of how features are rendered.

In various embodiments, the visual representation may be interactive, allowing the user to select individual features to view additional information or perform editing operations. Hovering over or clicking on a feature may display a popup with attribute data for that feature.

The computing device may utilize graphics acceleration hardware, such as a GPU, to efficiently render complex visual representations of large vector datasets. Techniques like tiling and level-of-detail rendering may be employed to optimize performance.

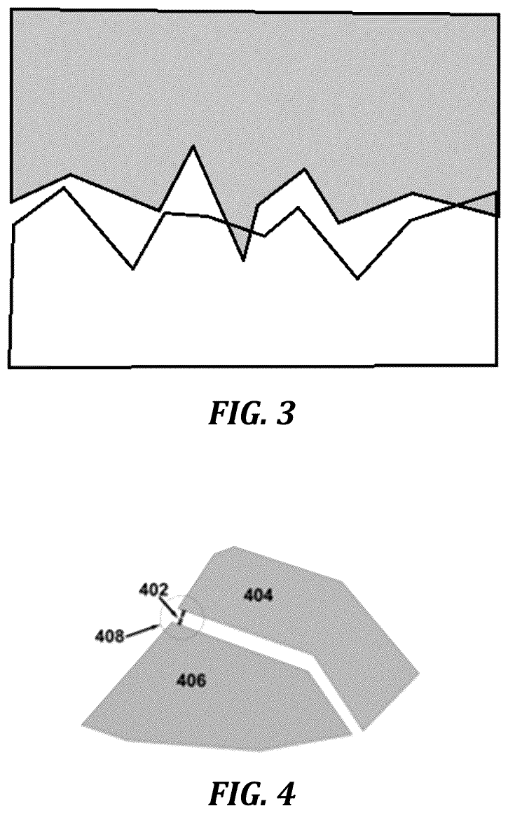

As one specific example, FIG. 3 shows two vector-based shape boundaries that are not aligned. This lack of alignment can create inconsistencies and/or reduce aesthetic appeal of the vector data. This lack of alignment may occur, for example, in maps where borders were not well-measured, and/or where different organizations measured borders for two adjacent regions.

In stage 215, the computing device 700 may provide a cursor on the graphical user interface. The cursor may be a visual indicator that represents the current position of a pointing device, such as a mouse, trackpad, or touchscreen input.

The cursor may take various forms depending on the context and user preferences. In some implementations, the cursor may appear as an arrow-shaped pointer. In other implementations, it may take the form of a hand icon, text insertion bar, or other shape appropriate for the current operation being performed.

The cursor may be movable across the graphical user interface in response to user input (e.g., from the pointing device). As the user moves the pointing device, the cursor may update its position in real-time to reflect the new location.

In some embodiments, the cursor may change appearance to provide visual feedback about available actions or the current system state. For example, it may transform into an hourglass or spinning icon to indicate that the system is processing an operation.

The computing device may render the cursor as an overlay on top of other graphical elements displayed in the user interface. This may allow the cursor to remain visible as it moves across different areas of the interface.

In various implementations, the cursor may be customizable in terms of size, color, shape and/or other visual properties. This customization may be performed to improve visibility or accessibility for different users.

The cursor may serve as the primary means for the user to interact with and manipulate elements within the graphical user interface. Its position may determine where clicks, drags, and other input actions are registered by the system.

The computing device 700 may display a threshold indicator around the cursor. The threshold indicator may define an area for identifying potential edges for alignment.

In some embodiments, the threshold indicator may be visualized as an area surrounding the cursor on the graphical user interface. The size and/or chape of this area may be configurable by the user to adjust the sensitivity of edge detection.

The threshold indicator may serve to visually delineate the region within which the system searches for potential alignment edges. As the user moves the cursor across the interface, the threshold indicator may move therewith, continuously updating the search area.

In various implementations, the threshold indicator may be rendered as a semi-transparent overlay on top of the vector data visualization. This may allow the user to see the underlying data while still clearly perceiving the bounds of the threshold area.

The system may analyze the vector data within the threshold indicator area to identify edges or vertices that may be candidates for alignment. These potential alignment targets may be highlighted or otherwise visually emphasized to draw the user's attention.

For example, as shown in FIG. 4, as the user moves their pointer device so that the threshold indicator 408 surrounds at least a portion of two edges that are candidates for alignment (e.g., edges of regions 404, 406), the platform may provide graphical feedback represented by arrows 402 pointing to a new alignment point of the edges that are candidates for alignment.

The threshold indicator may incorporate visual cues to provide feedback on the density or proximity of potential alignment edges within its bounds. For instance, the indicator's color or opacity may change based on how many candidate edges are detected.

In stage 220, the computing device may detect a user input to initiate an alignment process. In stage 220, the computing device 700 may detect a user input to initiate an alignment process.

The user input may be detected via an input device such as a mouse, touchpad, touchscreen, or other pointing device connected to the computing device 700.

In some implementations, the user input may comprise a click-and-drag action performed with the pointing device. The click-and-drag action may involve the user pressing down on a button or surface of the pointing device, moving the pointing device while maintaining the press, and then releasing the press.

The computing device 700 may monitor for this type of click-and-drag input within the graphical user interface displaying the vector data visualization. When such an input is detected, it may be interpreted as the user's intent to initiate the alignment process.

In other implementations, the user input to initiate alignment may comprise a keyboard shortcut, menu selection, or activation of an on-screen button or control element specifically designated for starting the alignment tool.

The computing device 700 may register the starting position of the user input, such as the coordinates where the initial click or press occurred. This starting position may be used as a reference point for subsequent stages of the alignment process.

Upon detecting the initiating user input, the computing device 700 may activate additional event listeners or input handlers specifically designed to track and interpret user actions during the alignment process.

The detection of the initiating user input may trigger the computing device 700 to transition from a general interaction mode into a specialized alignment mode, potentially changing the appearance of the cursor or displaying additional visual guides and feedback elements.

In some embodiments, the computing device 700 may perform initial calculations or analyses upon detecting the initiating input, such as identifying the nearest vector edges to the input location or determining potential alignment targets within the threshold area.

The detection of the user input to initiate alignment may also cause the computing device 700 to begin logging or recording the subsequent user actions and interface state changes for purposes such as creating an undo history or generating usage analytics.

Responsive to the initiation of the alignment process, the computing device may identify, within the threshold indicator area, at least two edges for alignment in stage 225. In some implementations, the edge identification module may identify at least two potential edges for alignment within the threshold indicator area. The threshold indicator area may be defined as a region surrounding the cursor on the graphical user interface. This area may be visually represented, for example, by the threshold indicator.

The edge identification module may employ various techniques to detect and classify potential edges within the threshold area. In one approach, the module may analyze the vector coordinates of features present within the threshold area. The module may examine the spatial relationships between coordinate points to identify linear segments that may represent edges of geographic features or graphic design elements.

In some embodiments, the edge identification module may utilize edge detection algorithms to process the vector data within the threshold area. These algorithms may be configured to detect abrupt changes or discontinuities in the vector data that may indicate the presence of an edge. The edge detection may involve techniques such as gradient analysis, where the rate of change in coordinate values is evaluated to highlight potential edge locations.

The module may classify detected edges based on various characteristics. In some implementations, the length of an edge segment may be considered as a classification criterion. For example, longer edge segments may be given higher priority as potential alignment targets. The orientation of edge segments may also be analyzed, with the module potentially favoring edges that align with major axes or exhibit particular angular relationships.

As the user moves the cursor across the interface, the threshold indicator area may dynamically update its position. In response, the edge identification module may periodically or continuously re-evaluate the vector data within the new threshold area. This dynamic updating may allow for real-time identification of potential edges as the user explores different regions of the vector data visualization.

In some embodiments, the edge identification module may employ machine learning techniques to improve its edge detection capabilities over time. The module may analyze user selections and alignments to refine its understanding of what constitutes a relevant edge for alignment purposes in different contexts.

The edge identification module may assign confidence scores to detected edges based on how closely they match predefined edge criteria. These scores may be used to prioritize which potential edges are presented to the user for alignment.

In some implementations, the module may identify more than two potential edges within the threshold area. The system may apply additional filtering or prioritization steps to select the two most relevant edges for the current alignment operation.

The edge identification process may take into account the current zoom level or scale of the vector data visualization. At higher zoom levels, the module may adjust its sensitivity to detect finer edge details, while at lower zoom levels it may focus on more prominent edge features.

In certain embodiments, the edge identification module may consider the topology of the vector data when identifying potential edges. For example, it may prioritize edges that form boundaries between distinct geographic features or separate design elements.

The results of the edge identification process may be communicated to other components of the system, such as the interface module, to provide visual feedback to the user. This feedback may include highlighting or otherwise emphasizing the identified potential edges within the graphical user interface.

In stage 230, the computing device 700 may determine an alignment method from a plurality of candidate alignment methods. The alignment method may be selected based on user input or predefined settings. In some implementations, the plurality of candidate alignment methods may include at least one of a “meet in the middle” method or a “meet at first edge” method.

The “meet in the middle” method may generate an average line between the identified potential edges for alignment. This method may calculate new alignment points that fall between the corresponding points on the two edges being aligned.

The “meet at first edge” method may align a second edge to a first edge. This method may preserve the geometry of the first edge and adjust the second edge to match it.

In some embodiments, the computing device 700 may present a user interface allowing the user to select the desired alignment method. The user interface may include buttons, dropdown menus, or other input mechanisms for choosing between the available alignment methods.

The computing device 700 may store the selected alignment method in memory for use in subsequent alignment calculations. The selected method may be applied consistently across the current alignment operation, or the user may be allowed to switch methods during the process.

In certain implementations, the computing device 700 may analyze characteristics of the identified potential edges and automatically suggest an appropriate alignment method. For example, if the edges are nearly parallel, the “meet in the middle” method may be recommended. If one edge appears to be a more authoritative boundary, the “meet at first edge” method may be suggested.

The determination of the alignment method may occur before or after the user initiates the alignment operation. In some embodiments, a default method may be preselected, with the option for the user to change it before executing the alignment.

The selected alignment method may influence how the computing device 700 calculates and applies the alignment in subsequent stages of the process. The method choice may affect factors such as which edge points are used as references, how new coordinates are computed, and how the original vector data is modified.

In stage 235, the computing device may define an extent of alignment along the identified edges. In some implementations, the computing device 700 may define an extent of alignment along the identified potential edges. The extent of alignment may represent the portion of the edges that will be modified during the alignment process.

To define the extent of alignment, the computing device 700 may detect a user input indicating a start point and an end point along the identified potential edges. In one embodiment, this user input may be in the form of a click-and-drag action using a pointing device such as a mouse or touchpad.

As the user performs the click-and-drag action, the computing device 700 may continuously update a visual indicator on the graphical user interface to show the current extent of the proposed alignment. This visual indicator may take the form of a highlighted line segment or shaded region between the identified potential edges.

In some implementations, the computing device 700 may constrain the extent of alignment based on certain geometric criteria. For example, the extent may be limited to portions of the edges that are within a specified distance threshold of each other. This threshold may be configurable by the user.

The computing device 700 may analyze the vector data of the identified potential edges to determine valid alignment segments. In one embodiment, this analysis may involve identifying continuous line segments or curve segments that can be aligned without introducing topological errors or invalid geometries.

In some cases, the computing device 700 may automatically suggest an optimal extent of alignment based on factors such as the length of parallel edge segments, the proximity of the edges, and/or the presence of existing intersection points. The user may have the option to accept the suggested extent or to manually modify the suggested extent.

The defined extent of alignment may be stored by the computing device 700 as a set of start and end coordinates or index values referencing specific vertices along the identified potential edges. This information may be used in subsequent steps to calculate and apply the alignment.

In certain implementations, the computing device 700 may allow the user to define multiple disjoint segments for alignment along the same pair of potential edges. This may be useful for aligning complex geometries with varying degrees of misalignment along their length.

The computing device 700 may provide visual feedback to confirm the final extent of alignment selected by the user. This feedback may include displaying the defined extent with a distinctive color or pattern, or showing numeric values indicating the length or percentage of the edges to be aligned.

The computing device 700 may calculate new alignment points based on the selected alignment method and the defined extent in stage 240. In some implementations, the computing device 700 may calculate new alignment points based on the selected alignment method and the defined extent. The calculation of new alignment points may be performed by the alignment determination module of the computing device 700.

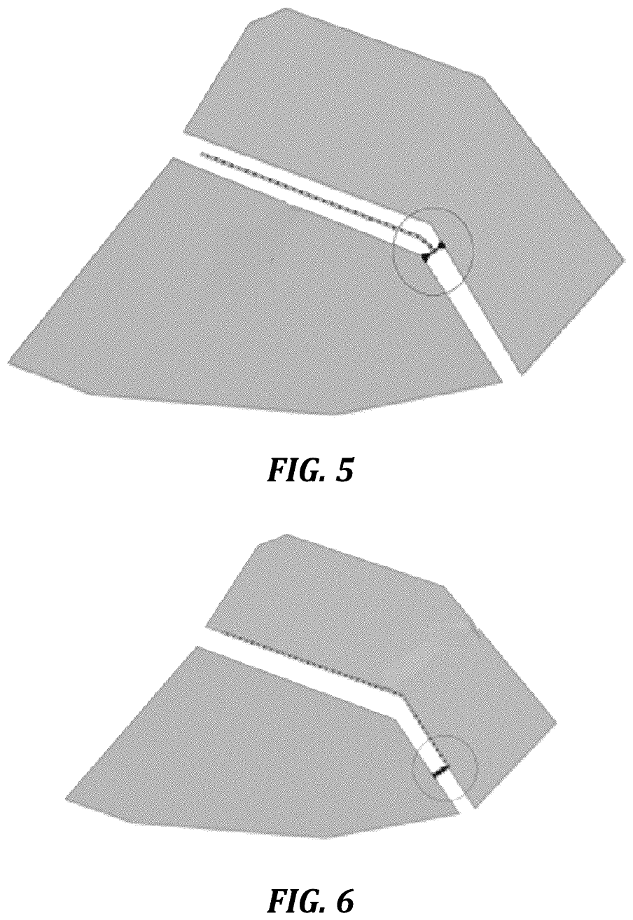

For the “meet in the middle” alignment method, the computing device 700 may generate an average line between the identified potential edges for alignment, as shown in FIG. 5. This process may involve calculating the midpoint between corresponding points on the two edges being aligned.

The computing device 700 may first identify corresponding points on each edge within the defined extent of alignment. These corresponding points may be determined based on their relative positions along the edges or by projecting points from one edge onto the other.

For each pair of corresponding points, the computing device 700 may calculate asset of midpoint coordinates. For example, in a Cartesian coordinate system, this calculation may involve calculating an average of the x and y coordinates (and z coordinates if applicable) of the two points.

The resulting set of midpoint coordinates may form the new alignment points for the “meet in the middle” method. These new alignment points may define the average line that falls between the two original edges.

In some implementations, the computing device 700 may apply a smoothing algorithm to the calculated midpoints to ensure a consistent and visually appealing aligned edge. This smoothing process may involve techniques such as curve fitting or spline interpolation.

For the “meet at first edge” alignment method, the computing device 700 may use the geometry of the first edge as the basis for alignment. The first edge may be defined as the edge closest to the cursor when the alignment process was initiated. Alternatively, the user may select an edge to be interpreted as the first edge.

In this method, the computing device 700 may project points from the second edge onto the first edge within the defined extent of alignment. The projection may be performed perpendicular to the first edge or using other geometric criteria.

The projected points on the first edge may serve as the new alignment points for the second edge. This approach preserves the geometry of the first edge while modifying the second edge to match it, as shown in FIG. 6.

In some implementations, the computing device 700 may interpolate additional points along the first edge to ensure a smooth and accurate alignment, especially in cases where the edges have different densities of vertices.

The computing device 700 may store the calculated new alignment points in memory. These points may be associated with their corresponding original edge points to facilitate the subsequent modification of the vector data.

In some embodiments, the computing device 700 may perform additional calculations to ensure that the new alignment points maintain the topological relationships of the original vector data. This may involve adjusting the positions of adjacent vertices or recalculating intersections with other vector features.

The computing device 700 may calculate and store metadata associated with the new alignment points. This metadata may include information such as the original edge identifiers, the alignment method used, and any parameters applied during the calculation process.

In certain implementations, the computing device 700 may employ optimization algorithms to refine the positions of the new alignment points. These algorithms may aim to minimize the overall displacement of vertices while achieving the desired alignment.

The calculation of new alignment points may take into account any user-specified constraints or options, such as “square ends” functionality. When this option is selected, the computing device 700 may calculate additional points at the start and end of the aligned edges to maintain the angular geometry of contiguous line segments.

In some embodiments, the computing device 700 may perform real-time updates of the new alignment point calculations as the user modifies the extent of alignment or switches between alignment methods. This may enable dynamic visual feedback during the alignment process.

In stage 245, the computing device 700 may modify the vector data (e.g., the vector data received in stage 205) to incorporate the calculated new alignment points. In some embodiments, the computing device 700 may modify the vector data to incorporate the calculated new alignment points. The vector modification module may splice the new alignment points into the existing vector data at the appropriate indices.

For the “meet in the middle” alignment method, the computing device 700 may insert the calculated average points into both edges being aligned. The new points may be spliced into each edge at the corresponding indices specified by the user selection during the alignment process.

For the “meet at first edge” alignment method, the computing device 700 may leave the first edge unmodified and splice the points from the first edge into the second edge at the corresponding indices. This preserves the detail of the first edge while aligning the second edge to match it.

In some implementations, the computing device 700 may adjust adjacent vertices and/or recalculate intersections with other vector features to maintain proper topological relationships after modifying the vector data. This may involve shifting nearby vertices and/or updating connectivity information between features.

The computing device 700 may update any associated metadata or attributes of the modified vector features to reflect the alignment changes. This may include recalculating lengths, areas, or other geometric properties affected by the alignment.

In certain embodiments, the computing device 700 may create a new version or copy of the vector data with the alignment modifications, while preserving the original unmodified data. This allows for comparison or reversion if needed.

The computing device 700 may apply any user-specified options, such as adding square ends, when modifying the vector data. For square ends, additional points may be inserted before the first and after the last aligned point to maintain angular geometry with adjacent segments.

In some implementations, the computing device 700 may perform a validation check after modifying the vector data to ensure the changes have not introduced any topological errors or inconsistencies. Any issues detected may be automatically resolved or flagged for user review.

The modified vector data may be rendered on the display to provide immediate visual feedback to the user on the results of the alignment operation. The computing device 700 may highlight or otherwise emphasize the modified portions to clearly indicate the changes made.

### IV. Hardware Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 700. The computing device 700 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
Platform 100 may be hosted on a centralized server or a cloud computing service. Although method 200 has been described to be performed by a computing device 700, it should be understood that, in some embodiments, different operations may be performed by a plurality of the computing devices 700 in operative communication on at least one network.

Embodiments of the present disclosure may comprise a system having a central processing unit (CPU) 720, a bus 730, a memory unit 740, a power supply unit (PSU) 750, and one or more Input/Output (I/O) units. The CPU 720 coupled to the memory unit 740 and the plurality of I/O units 760 via the bus 730, all of which are powered by the PSU 750. It should be understood that, in some embodiments, each disclosed unit may actually be a plurality of such units for redundancy, high availability, and/or performance purposes. The combination of the presently disclosed units is configured to perform the stages of any method disclosed herein.

FIG. 7 is a block diagram of a system including computing device 700. Consistent with an embodiment of the disclosure, the aforementioned CPU 720, the bus 730, the memory unit 740, a PSU 750, and the plurality of I/O units 760 may be implemented in a computing device, such as computing device 700 of FIG. 7. Any suitable combination of hardware, software, or firmware may be used to implement the aforementioned units. For example, the CPU 720, the bus 730, and the memory unit 740 may be implemented with computing device 700 or any of other computing devices 700, in combination with computing device 700. The aforementioned system, device, and components are examples and other systems, devices, and components may comprise the aforementioned CPU 720, the bus 730, and the memory unit 740, consistent with embodiments of the disclosure.

At least one computing device 700 may be embodied as any of the computing elements illustrated in all of the attached figures. A computing device 700 does not need to be electronic, nor even have a CPU 720, nor bus 730, nor memory unit 740. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In some configurations, the computing device 700 may include at least one clock module 710, at least one CPU 720, at least one bus 730, and at least one memory unit 740, at least one PSU 750, and at least one I/O 760 module, wherein I/O module may be comprised of, but not limited to a non-volatile storage sub-module 761, a communication sub-module 762, a sensors sub-module 763, and a peripherals sub-module 764.

In a system consistent with an embodiment of the disclosure, the computing device 700 may include the clock module 710, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 720, the central component of modern computers, which relies on a clock signal. The clock 710 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 700 may use a “clock multiplier” which multiplies a lower frequency external clock to the appropriate clock rate of the CPU 720. This allows the CPU 720 to operate at a much higher frequency than the rest of the computing device 700, which affords performance gains in situations where the CPU 720 does not need to wait on an external factor (like memory 740 or input/output 760). Some embodiments of the clock 710 may include dynamic frequency change where the time between clock edges can vary widely from one edge to the next and back again.

In a system consistent with an embodiment of the disclosure, the computing device 700 may include the CPU 720 comprising at least one CPU Core 721. In other embodiments, the CPU 720 may include a plurality of identical CPU cores 721, such as, but not limited to, homogeneous multi-core systems. It is also possible for the plurality of CPU cores 721 to comprise different CPU cores 721, such as, but not limited to, heterogeneous multi-core systems, big.LITTLE systems and some AMD accelerated processing units (APU). The CPU 720 reads and executes program instructions which may be used across many application domains, for example, but not limited to, general purpose computing, embedded computing, network computing, digital signal processing (DSP), and graphics processing (GPU). The CPU 720 may run multiple instructions on separate CPU cores 721 simultaneously. The CPU 720 may be integrated into at least one of a single integrated circuit die, and multiple dies in a single chip package. The single integrated circuit die and/or the multiple dies in a single chip package may contain a plurality of other elements of the computing device 700, for example, but not limited to, the clock 710, the bus 730, the memory 740, and I/O 760.

The CPU 720 may contain cache 722 such as but not limited to a level 1 cache, a level 2 cache, a level 3 cache, or combinations thereof. The cache 722 may or may not be shared amongst a plurality of CPU cores 721. The cache 722 sharing may comprise at least one of message passing and inter-core communication methods used for the at least one CPU Core 721 to communicate with the cache 722. The inter-core communication methods may comprise, but not be limited to, bus, ring, two-dimensional mesh, and crossbar. The aforementioned CPU 720 may employ symmetric multiprocessing (SMP) design.

The one or more CPU cores 721 may comprise soft microprocessor cores on a single field programmable gate array (FPGA), such as semiconductor intellectual property cores (IP Core). The architectures of the one or more CPU cores 721 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the computing device 700, and/or the plurality of computing devices 700. The aforementioned communication system will be known to a person having ordinary skill in the art as a bus 730. The bus 730 may embody internal and/or external hardware and software components, for example, but not limited to a wire, an optical fiber, various communication protocols, and/or any physical arrangement that provides the same logical function as a parallel electrical bus. The bus 730 may comprise at least one of a parallel bus, wherein the parallel bus carries data words in parallel on multiple wires; and a serial bus, wherein the serial bus carries data in bit-wise serial form. The bus 730 may embody a plurality of topologies, for example, but not limited to, a multidrop/electrical parallel topology, a daisy chain topology, and connected by switched hubs, such as a USB bus. The bus 730 may comprise a plurality of embodiments, for example, but not limited to:
Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard.
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)·
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 700 may employ hardware integrated circuits that store information for immediate use in the computing device 700, known to persons having ordinary skill in the art as primary storage or memory 740. The memory 740 operates at high speed, distinguishing it from the non-volatile storage sub-module 761, which may be referred to as secondary or tertiary storage, which provides relatively slower-access to information but offers higher storage capacity. The data contained in memory 740, may be transferred to secondary storage via techniques such as, but not limited to, virtual memory and swap. The memory 740 may be associated with addressable semiconductor memory, such as integrated circuits consisting of silicon-based transistors, that may be used as primary storage or for other purposes in the computing device 700. The memory 740 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 741, Static Random-Access Memory (SRAM) 742, CPU Cache memory 725, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 743, Programmable ROM (PROM) 744, Erasable PROM (EPROM) 745, Electrically Erasable PROM (EEPROM) 746 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 700 may employ a communication system between an information processing system, such as the computing device 700, and the outside world, for example, but not limited to, human, environment, and another computing device 700. The aforementioned communication system may be known to a person having ordinary skill in the art as an Input/Output (I/O) module 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces with a plurality of hardware, such as, but not limited to, non-volatile storage 761, communication devices 762, sensors 763, and peripherals 764. The plurality of hardware is used by at least one of, but not limited to, humans, the environment, and another computing device 700 to communicate with the present computing device 700. The I/O module 760 may comprise a plurality of forms, for example, but not limited to channel I/O, port mapped I/O, asynchronous I/O, and Direct Memory Access (DMA).

Consistent with the embodiments of the present disclosure, the aforementioned computing device 700 may employ a non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using an intermediate area in the memory 740. The non-volatile storage sub-module 761 may not lose data when power is removed and may be orders of magnitude less costly than storage used in memory 740. Further, the non-volatile storage sub-module 761 may have a slower speed and higher latency than in other areas of the computing device 700. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 700 may employ a communication sub-module 762 as a subset of the I/O module 760, which may be referred to by a person having ordinary skill in the art as at least one of, but not limited to, a computer network, a data network, and a network. The network may allow computing devices 700 to exchange data using connections, which may also be known to a person having ordinary skill in the art as data links, which may include data links between network nodes. The nodes may comprise networked computer devices 700 that may be configured to originate, route, and/or terminate data. The nodes may be identified by network addresses and may include a plurality of hosts consistent with the embodiments of a computing device 700. Examples of computing devices that may include a communication sub-module 762 include, but are not limited to, personal computers, phones, servers, drones, and networking devices such as, but not limited to, hubs, switches, routers, modems, and firewalls.

Two nodes can be considered networked together when one computing device 700 can exchange information with the other computing device 700, regardless of any direct connection between the two computing devices 700. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPV6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 762 may comprise a plurality of size, topology, traffic control mechanisms and organizational intent policies. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 700 may employ a sensors sub-module 763 as a subset of the I/O 760. The sensors sub-module 763 comprises at least one of the device, module, or subsystem whose purpose is to detect events or changes in its environment and send the information to the computing device 700. Sensors may be sensitive to the property they are configured to measure, may not be sensitive to any property not measured but be encountered in its application, and may not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ a peripherals sub-module 764 as a subset of the I/O 760. The peripheral sub-module 764 comprises ancillary devices uses to put information into and get information out of the computing device 700. There are 3 categories of devices comprising the peripheral sub-module 764, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 700. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 764:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 700. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 700 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 700. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)·
Input/Output Devices may further comprise, but not be limited to, touchscreens, networking devices (e.g., devices disclosed in network sub-module 762), data storage devices (non-volatile storage 761), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A computer-implemented method for aligning vector coordinates, comprising:
receiving, by a processor, vector data representing boundaries of features comprised of vector points;
displaying, on a graphical user interface, a visual representation of the vector data;
providing a cursor on the graphical user interface;
displaying a threshold indicator around the cursor, wherein the threshold indicator defines an area for identifying potential edges for alignment;
detecting a user input to initiate an alignment process;
identifying, within the threshold indicator area, at least two potential edges for alignment;
receiving a user selection of an alignment method from a plurality of alignment methods;
receiving a user input defining an extent of alignment along the identified potential edges;
calculating new alignment points based on the selected alignment method and defined extent; and
modifying the vector data to incorporate the calculated new alignment points.

2. The method of claim 1, wherein the plurality of alignment methods comprises at least one of:
a “meet in the middle” method that generates an average line between the identified potential edges; and
a “meet at first edge” method that aligns a second edge to a first edge.

3. The method of claim 1, further comprising:
receiving a user selection to add square ends; and
in response to the user selection, adding points at a start and end of aligned edges to maintain angular geometry of contiguous line segments.

4. The method of claim 1, wherein detecting the user input to initiate the alignment process comprises detecting a click-and-drag action of a pointing device.

5. The method of claim 1, further comprising:
providing real-time visual feedback during the alignment process, wherein the visual feedback comprises a preview of a new aligned edge and directional indicators pointing from existing edges towards the new aligned edge.

6. The method of claim 1, wherein the threshold indicator is a circular area around the cursor, and wherein a size of the circular area is configurable by a user.

7. The method of claim 1, wherein the alignment process comprises:
a discovery stage for selecting initial points for edge alignment;
a selection stage for defining an extent of alignment; and
an alignment stage for executing the alignment and modifying the vector data.

8. A system for aligning vector coordinates, comprising:
a display device;
a processor; and
a memory storing instructions that, when executed by the processor, cause the system to:
display a graphical user interface on the display device;
render vector data representing boundaries of features comprised of vector points on the graphical user interface;
provide a cursor and a threshold indicator around the cursor on the graphical user interface;
detect user inputs for selecting potential edges for alignment within the threshold indicator;
receive a selection of an alignment method;
calculate new alignment points based on the selected alignment method and user inputs; and
modify the vector data to incorporate the calculated new alignment points.

9. The system of claim 8, wherein the instructions further cause the system to:
provide configuration options for the alignment process, wherein the configuration options include at least one of: threshold indicator size, alignment method selection, and square ends option.

10. The system of claim 8, wherein the instructions further cause the system to:
provide real-time visual feedback during the alignment process, the visual feedback comprising a preview of new aligned edges and directional indicators.

11. The system of claim 8, wherein the alignment method is selected from a group consisting of:
a “meet in the middle” method that generates an average line between selected edges; and
a “meet at first edge” method that aligns a second edge to a first edge.

12. The system of claim 8, wherein the instructions further cause the system to:
detect a click-and-drag action to define an extent of alignment along selected edges.

13. The system of claim 8, wherein the instructions further cause the system to:
add points at a start and end of aligned edges to maintain angular geometry of contiguous line segments in response to a user selection of a square ends option.

14. A non-transitory computer-readable medium storing instructions that, when executed by a processor, cause the processor to perform a method for aligning vector coordinates, the method comprising:
displaying a graphical user interface with vector data representing boundaries of features comprised of vector points;
providing a cursor and a threshold indicator around the cursor on the graphical user interface;
detecting user inputs for selecting potential edges for alignment within the threshold indicator;
receiving a selection of an alignment method from a plurality of alignment methods;
calculating new alignment points based on the selected alignment method and user inputs; and
modifying the vector data to incorporate the calculated new alignment points.

15. The non-transitory computer-readable medium of claim 14, wherein the method further comprises:
providing real-time visual feedback during an alignment process, the visual feedback comprising a preview of new aligned edges and directional indicators.

16. The non-transitory computer-readable medium of claim 14, wherein the plurality of alignment methods comprises:
a “meet in the middle” method that generates an average line between selected edges; and
a “meet at first edge” method that aligns a second edge to a first edge.

17. The non-transitory computer-readable medium of claim 14, wherein the method further comprises:
detecting a click-and-drag action to define an extent of alignment along selected edges.

18. The non-transitory computer-readable medium of claim 14, wherein the method further comprises:
adding points at a start and end of aligned edges to maintain angular geometry of contiguous line segments in response to a user selection of a square ends option.

19. The non-transitory computer-readable medium of claim 14, wherein the threshold indicator is a circular area around the cursor, and wherein a size of the circular area is configurable by a user.

20. The non-transitory computer-readable medium of claim 14, wherein the method further comprises:
providing configuration options for the alignment process, wherein the configuration options include at least one of: threshold indicator size, alignment method selection, and square ends option.
